(19) United States
(12) Patent Application Publication
(10) Pub. No.: US 2026/0173146 A1
(43) Pub. Date: Jun. 18, 2026

(54) RANDOM ACCESS RESOURCES FOR COLLISION HANDLING

(71) Applicant: QUALCOMM Incorporated, San Diego, CA (US)

(72) Inventors: Ahmed Attia ABOTABL, San Diego, CA (US); Diana MAAMARI, San Diego, CA (US); Marwen ZORGUI, San Diego, CA (US)

(21) Appl. No.: 18/980,356

(22) Filed: Dec. 13, 2024

(51) Int. Cl. H04W 74/0833; H04W 76/38

(52) U.S. Cl. CPC H04W 74/0833; H04W 76/38

(57) ABSTRACT

Various aspects of the present disclosure generally relate to wireless communication. In some aspects, a first network entity may transmit, during a first random access channel (RACH) occasion of one or more first RACH occasions, a first random access message that includes a first random access preamble. The first network entity may receive information indicating that one or more second RACH occasions are activated based on the first random access message being associated with a collision. The first network entity may transmit, during a second RACH occasion of the one or more second RACH occasions, a second random access message that includes a second random access preamble. Numerous other aspects are described.

### FIELD OF THE DISCLOSURE

Aspects of the present disclosure generally relate to wireless communication and specifically relate to techniques, apparatuses, and methods associated with random access resources for collision handling.

### INTRODUCTION

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some aspects, a first network entity includes a processing system configured to: transmit, during a first random access channel (RACH) occasion of one or more first RACH occasions, a first random access message that includes a first random access preamble; receive information indicating that one or more second RACH occasions are activated based on the first random access message being associated with a collision; and transmit, during a second RACH occasion of the one or more second RACH occasions, a second random access message that includes a second random access preamble.

In some aspects, a method of wireless communication performed by a first network entity includes transmitting, during a first RACH occasion of one or more first RACH occasions, a first random access message that includes a first random access preamble; receiving information indicating that one or more second RACH occasions are activated based on the first random access message being associated with a collision; and transmitting, during a second RACH occasion of the one or more second RACH occasions, a second random access message that includes a second random access preamble.

In some aspects, a non-transitory computer-readable medium has code stored thereon that, when executed by a first network entity, causes the first network entity to: transmit, during a first RACH occasion of one or more first RACH occasions, a first random access message that includes a first random access preamble; receive information indicating that one or more second RACH occasions are activated based on the first random access message being associated with a collision; and transmit, during a second RACH occasion of the one or more second RACH occasions, a second random access message that includes a second random access preamble.

In some aspects, an apparatus for wireless communication includes means for transmitting, during a first RACH occasion of one or more first RACH occasions, a first random access message that includes a first random access preamble; means for receiving information indicating that one or more second RACH occasions are activated based on the first random access message being associated with a collision; and means for transmitting, during a second RACH occasion of the one or more second RACH occasions, a second random access message that includes a second random access preamble.

In some aspects, a first network entity includes a processing system configured to: receive, during a first RACH occasion of one or more first RACH occasions, a first random access message associated with a second network entity, wherein the first random access message includes a first random access preamble; transmit information indicating that one or more second RACH occasions are activated based on the first random access message being associated with a collision; and receive, during a second RACH occasion of the one or more second RACH occasions, a second random access message associated with the second network entity, wherein the second random access message includes a second random access preamble.

In some aspects, a method of wireless communication performed by a first network entity includes receiving, during a first RACH occasion of one or more first RACH occasions, a first random access message associated with a second network entity, wherein the first random access message includes a first random access preamble; transmitting information indicating that one or more second RACH occasions are activated based on the first random access message being associated with a collision; and receiving, during a second RACH occasion of the one or more second RACH occasions, a second random access message associated with the second network entity, wherein the second random access message includes a second random access preamble.

In some aspects, a non-transitory computer-readable medium has code stored thereon that, when executed by a first network entity, causes the first network entity to: receive, during a first RACH occasion of one or more first RACH occasions, a first random access message associated with a second network entity, wherein the first random access message includes a first random access preamble; transmit information indicating that one or more second RACH occasions are activated based on the first random access message being associated with a collision; and receive, during a second RACH occasion of the one or more second RACH occasions, a second random access message associated with the second network entity, wherein the second random access message includes a second random access preamble.

In some aspects, an apparatus for wireless communication includes means for receiving, during a first RACH occasion of one or more first RACH occasions, a first random access message associated with a second network entity, wherein the first random access message includes a first random access preamble; means for transmitting information indicating that one or more second RACH occasions are activated based on the first random access message being associated with a collision; and means for receiving, during a second RACH occasion of the one or more second RACH occasions, a second random access message associated with the second network entity, wherein the second random access message includes a second random access preamble.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

The appended drawings illustrate certain example aspects of this disclosure and are therefore not limiting in scope. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram illustrating an example of a wireless communication network, in accordance with the present disclosure.

FIG. 3 is a diagram illustrating an example disaggregated network node architecture, in accordance with the present disclosure.

FIG. 4 is a diagram illustrating an example of a two-step random access procedure, in accordance with the present disclosure.

FIG. 5 is a diagram illustrating an example of a four-step random access procedure, in accordance with the present disclosure.

FIG. 6 is a diagram illustrating an example of an activation of random access resource activation, in accordance with the present disclosure.

FIG. 7 is a diagram of an example associated with random access resources for collision handling, in accordance with the present disclosure.

FIG. 8 is a diagram of an example associated with random access resources for collision handling, in accordance with the present disclosure.

FIG. 9 is a diagram illustrating an example process performed, for example, at a first network entity or an apparatus of a first network entity, in accordance with the present disclosure.

FIG. 10 is a diagram illustrating an example process performed, for example, at a first network entity or an apparatus of a first network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. The scope of the disclosure covers any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure covers an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a user equipment (UE) may perform a random access procedure (e.g., a random access channel (RACH) procedure) with a network node to enable the UE to establish a connection with the network node, such as for an initial access, a link recovery, and/or a beam failure recovery, among other examples. The RACH procedure may include the exchange of one or more random access messages between the UE and the network node. For example, the UE may transmit a preamble, such as a physical RACH (PRACH) preamble. In some examples, the UE may utilize resources that are configured (such as via system information signaling) for initiating random access procedures with the network node. As part of the random access procedure, the UE may transmit a random access message (RAM) that includes the preamble. The UE may transmit the RAM via a RACH. The network node may transmit, and the UE may receive, a random access response (RAR). The UE can use the RAR to perform synchronization and establish a communication connection with the network node. The random access procedure may enable the network node to manage network resources efficiently by ensuring that multiple UEs can simultaneously and reliably request access to the wireless communication network, even in dense environments or deployments.

In some examples, two or more UEs may transmit random access messages (e.g., msg1 communications) to a network node using the same preamble (e.g., the same PRACH preamble) and the same RACH occasion (e.g., using the same time domain and/or frequency domain resources to transmit the RAM). As used herein, “collision” refers to a scenario in which two or more UEs transmit a RAM using the same preamble and during the same RACH occasion. A collision may also be referred to as a RACH collision, a PRACH collision, a preamble collision, a sequence (e.g., a preamble sequence) collision, and/or a sequence domain collision, among other examples. In such examples, the network node may be unable to distinguish between the two or more UEs. As a result, the network node may (e.g., in response to receiving multiple RAMs with the same preamble and via the same RACH occasion) consider a single UE to be detected. The network node may transmit a single RAR (e.g., in response to the multiple RAMs). Each UE (from the two or more UEs) may determine that a resource allocation indicated by the single RAR is granted for that UE. For example, each UE will treat an RAR uplink grant (e.g., indicated in an msg2) as allocated to itself (because the RAR uplink grant will use the preamble transmitted by each UE as a temporary ID to distinguish UEs). Each UE (from the two or more UEs) may transmit an msg3 using the resource allocation indicated by the single RAR (e.g., each UE may use the same RAR uplink grant to transmit an msg3).

As a result, the network node may perform one or more contention resolution operations to distinguish the two or more UEs that transmit respective msg3 communications using the same RAR uplink grant. This may consume processing resources, memory resources, and/or power resources associated with performing the contention resolution. In some cases, because the two or more UEs transmit respective msg3 communications using the same RAR uplink grant, the network node may fail to receive one or more of the msg3 communications (e.g., due to interference or other factors). As a result, UE(s) that transmit the failed msg3 communications may be unable to establish a connection with the network node, resulting in the UE(s) re-initiating the RACH procedure (e.g., thereby increasing latency associated with establishing a network connection and consuming network resources, processing resources, memory resources, and/or power resources associated with performing another RACH procedure).

In some examples, one or more random access preambles may be reserved for collision resolution. In such examples, UEs that transmit a random access preamble associated with a collision may retry a RAM transmission using a random access preamble from the one or more random access preambles reserved for collision resolution. However, this reduces the quantity of random access preambles available for use by the UEs when retrying the RAM transmission after a collision. Additionally, the reduced quantity of random access preambles available for use by the UEs when retrying the RAM transmission may increase the likelihood of another collision associated with the retried RAM transmission (e.g., as there may be a higher likelihood that two UEs select the same random access preamble from the one or more random access preambles reserved for collision resolution).

Various aspects relate generally to random access resources (e.g., PRACH resources) for collision handling. Some aspects more specifically relate to one or more network entities using random access that can be dynamically activated (e.g., using lower layer signaling, such as Layer 1 signaling) to resolve random access preamble collisions. In some aspects, a first network entity (e.g., a network node) may adapt PRACH transmissions based on detecting a collision (e.g., a condition for adapting PRACH transmissions may include the detection of the collision). Adapting PRACH transmissions may include activating one or more random access resources (e.g., PRACH resources, such as one or more RACH occasions) to be used by second network entities (e.g., one or more UEs) that transmitted a random access preamble involved in the collision. For example, the first network entity may activate one or more additional random access resources (e.g., PRACH resources, such as one or more RACH occasions) to be used by the second network entities that transmitted a random access preamble involved in the collision.

For example, the second network entities may transmit, and the first network entity may receive, random access messages (e.g., RAMs) that include the same random access preamble during a given RACH occasion (e.g., during first random access resources). The given RACH occasion may be included in one or more default RACH occasions (e.g., for which monitoring is not optional for the first network entity). The first network entity may detect the collision associated with the random access preamble transmitted by multiple network entities (e.g., multiple UEs) during the given RACH occasion. The first network entity may transmit, and the second network entities may receive, information indicating that one or more second RACH occasions (e.g., second random access resources) are activated based on the random access preamble transmitted being associated with the collision. The second network entities may transmit, during the one or more second RACH occasions, second RAMs using new random access preambles. For example, the second network entities may select (e.g., randomly or as indicated by the first network entity) new random access preambles to be transmitted during the additional RACH occasions (e.g., the additional PRACH resources) activated by the first network entity.

Particular aspects of the subject matter described in this disclosure can be implemented to realize one or more of the following potential advantages. In some examples, the described techniques can be used to reduce the latency associated with resolving collisions associated with random access preambles. For example, by the first network entity transmitting the information to activate one or more additional RACH occasions (e.g., additional PRACH resources) after detecting the collision, network entities (e.g., UEs) associated with the collision can quickly retry a transmission of a random access preamble during the one or more additional RACH occasions. This reduces latency that would have otherwise been associated with the network entities (e.g., UEs) waiting for a next default RACH occasion to retry the transmission of a random access preamble. Additionally, by the first network entity using the one or more additional RACH occasions (e.g., additional PRACH resources) for collision resolution, the second network entities (e.g., UEs) can use a larger quantity of random access preambles for collision resolution (e.g., as compared to if a subset of random access preambles were reserved for collision resolution).

Various aspects of the disclosure are described more fully hereinafter with reference to the accompanying drawings. This disclosure may, however, be embodied in many different forms and is not limited to any specific structure, function, example, aspect, or the like presented throughout this disclosure. This disclosure includes, for example, any aspect disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, network entity, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

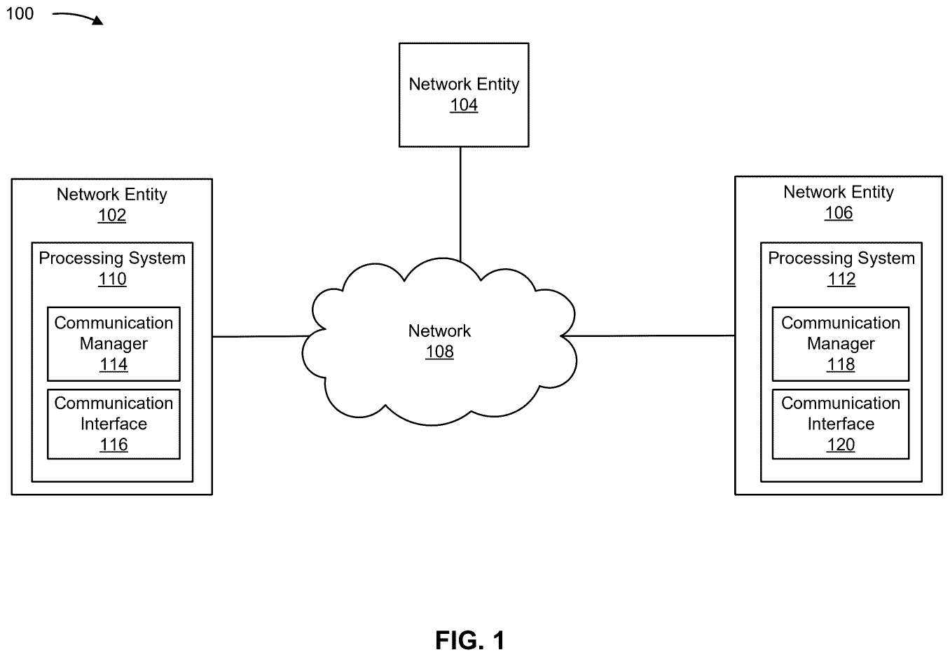

FIG. 1 is a diagram illustrating an example environment 100 in which apparatuses and/or methods described herein may be implemented, in accordance with the present disclosure. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary and/or mobile. The network 108 may include wired communication connections, wireless communication connections, or a combination of wired and wireless communication connections.

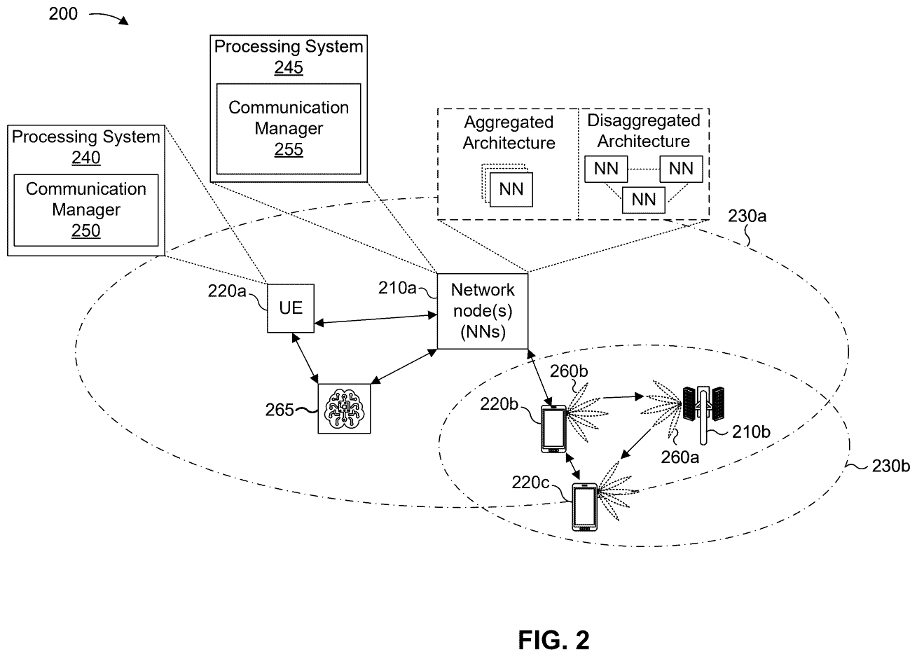

The network 108 may include, for example, a cellular network (e.g., a Long-Term Evolution (LTE) network, a CDMA network, a 4G network, a 5G network, a 6G network, or another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently

operating in the network. Rather, a network entity may be any entity that is capable of communicating and/or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 and/or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 and/or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, and/or a transceiver, among other examples. For example, a communication interface may include one or more transceivers, one or more receivers, and/or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, and/or a modulation component, among other examples.

A communication interface may include a transmission component and/or a reception component. For example, a communication interface may include a transceiver and/or one or more separate receivers and/or transmitters that enable a network entity to communicate with other devices, such as via a wired connection, a wireless connection, or a combination of wired and wireless connections. In some examples, a communication interface may include one or more radio frequency reflective elements and/or one or more radio frequency refractive elements. The communication interface may enable the network entity to receive information from another apparatus and/or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described herein, a network entity (e.g., the network entity 102 and/or the network entity 106) may be configured to perform one or more operations. Reference to a network entity being configured to perform one or more operations may refer to a processing system of the network entity being configured to perform the one or more operations and/or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, and/or at least one communication interface, among other examples, that are configured to perform one or more (or all) of the one or more operations, and/or any combination thereof. Where reference is made to the network entity and/or the processing system being configured to perform operations, the network entity and/or the processing system may be configured to cause one component to perform all operations, or to cause more than one component to collectively perform the operations. When the network entity and/or the processing system is configured to cause more than one component to collectively perform the operations, each operation need not be performed by each of those components (e.g., different operations may be performed by different components) and/or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) transmit, during a first random access channel (RACH) occasion of one or more first RACH occasions, a first random access message that includes a first random access preamble; receive information indicating that one or more second RACH occasions are activated based on the first random access message being associated with a collision; and/or transmit, during a second RACH occasion of the one or more second RACH occasions, a second random access message that includes a second random access preamble. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 114 and/or the communication interface 116 to) receive, during a first RACH occasion of one or more first RACH occasions, a first random access message associated with a second network entity, wherein the first random access message includes a first random access preamble; transmit information indicating that one or more second RACH occasions are activated based on the first random access message being associated with a collision; and/or receive, during a second RACH occasion of the one or more second RACH occasions, a second random access message associated with the second network entity, wherein the second random access message includes a second random access preamble. Additionally, or alternatively, the network entity 106 and/or the communication manager 118 may perform one or more other operations described herein.

The number and arrangement of entities shown in FIG. 1 are provided as one or more examples. In practice, there may be additional network entities and/or networks, fewer network entities and/or networks, different network entities and/or networks, or differently arranged network entities and/or networks than those shown in FIG. 1. Furthermore, the network entity 102, 104, and 106 may be implemented using a single apparatus or multiple apparatuses.

FIG. 2 is a diagram illustrating an example of a wireless communication network 200, in accordance with the present disclosure. The wireless communication network 200 may be or may include elements of a 5G (or NR) network or a 6G network, among other examples. The wireless communication network 200 may include multiple network nodes 210. For example, in FIG. 2, the wireless communication network 200 includes a network node (NN) 210a and a network node 210b. The network nodes 210 may support communications with multiple UEs 220. For example, in FIG. 2, the network nodes 210 support communication with a UE 220a, a UE 220b, and a UE 220c. In some examples, a UE 220 may also communicate with other UEs 220 and a network node 210 may communicate with a core network and with other network nodes 210.

The network nodes 210 and the UEs 220 of the wireless communication network 200 may communicate using the electromagnetic spectrum, which may be subdivided by frequency or wavelength into various classes, bands, carriers, and/or channels. For example, devices of the wireless communication network 200 may communicate using one or more operating bands. In some aspects, multiple wireless communication networks 200 may be deployed in a given geographic area. Each wireless communication network 200 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 200 may implement dynamic spectrum sharing (DSS), in which multiple RATs are implemented with dynamic bandwidth allocation (for example, based on user demand) in a single frequency band. In some examples, the wireless communication network 200 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 210 and/or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system, such as a processing system 240 of the UE 220 or a processing system 245 of the network node 210. The processing system 240 and the processing system 245 may be similar to other processing systems described herein, such as the processing system 110 and the processing system 112. A processing system (for example, the processing system 240 and/or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 and/or the processing system 245 include or implement one or more of the modems. The processing system 240 and the processing system 245 may also include or be coupled with multiple radios (collectively “the radio”), multiple RF chains, or multiple transceivers, each of which may in turn be coupled with one or more of multiple antennas. In some examples, one or more processors of the processing system 240 and/or the processing system 245 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 240 of the UE 220 or by the processing system 245 of the network node 210).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 210 and the UE 220.

A network node 210 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may consist of a single standalone base station or a single TRP that operates with a full radio protocol stack to enable or facilitate communication between a UE 220 and a core network of the wireless communication network 200.

Alternatively, and as also shown, a network node 210 may be a disaggregated network node (sometimes referred to as a disaggregated base station), having a disaggregated architecture, meaning that the network node 210 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 210 (for example, a base station, an RU, or a TRP) may provide communication coverage for a particular geographic area. The term “cell” can refer to a coverage area of a network node 210 or to a network node 210 itself, depending on the context in which the term is used. A network node 210 may support one or more cells (for example, each cell may support communication within an angular (for example, 60 degree) range around the network node). In some examples, a network node 210 may provide communication coverage for a macro cell, a pico cell, a femto cell, or another type of cell. A macro cell may cover a relatively large geographic area (for example, several kilometers in radius) and may allow unrestricted access by UEs 220 with associated service subscriptions. A pico cell may cover a relatively small geographic area and may also allow unrestricted access by UEs 220 with associated service subscriptions. A femto cell may cover a relatively small geographic area (for example, a home) and may allow restricted access by UEs 220 having association with the femto cell (for example, UEs 220 in a closed subscriber group (CSG)). In some examples, a cell may not necessarily be stationary. For example, the geographic area of the cell may move according to the location of an associated mobile network node 210 (for example, a train, a satellite, an unmanned aerial vehicle, or an NTN network node).

The wireless communication network 200 may be a heterogeneous network that includes network nodes 210 of different types, such as macro network nodes, pico network nodes, femto network nodes, relay network nodes, aggregated network nodes, and/or disaggregated network nodes, among other examples. Various different types of network nodes 210 may generally transmit at different power levels, serve different coverage areas (for example, a cell 230a and a cell 230b), and/or have different impacts on interference in the wireless communication network 200 than other types of network nodes 210.

The UEs 220 may be physically dispersed throughout the coverage area of the wireless communication network 200, and each UE 220 may be stationary or mobile. A UE 220 may be, may include, or may also be referred to as an access terminal, a mobile station, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 220 may be classified according to different categories in association with different complexities and/or different capabilities. UEs 220 in a first category may facilitate massive IoT in the wireless communication network 200, and may offer low complexity and/or cost relative to UEs 220 in a second category. UEs 220 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 200, among other examples. A third category of UEs 220 may have mid-tier complexity and/or capability (for example, a capability between that of the UEs 220 of the first category and that of the UEs 220 of the second capability). A UE 220 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) and/or reconfigured (for example, in real-time or near-real-time) according to changing network conditions in the wireless communication network 200 and/or specific requirements of one or more UEs 220. An active BWP defines the operating bandwidth of the UE 220 within the operating bandwidth of the serving cell. The use of BWPs enables more efficient use of the available frequency domain resources in the wireless communication network 200 because fewer frequency domain resources may be allocated to a BWP for a UE 220 (which may reduce the quantity of frequency domain resources that a UE 220 is required to monitor and reduce UE power consumption by enabling the UE to monitor fewer frequency domain resources), leaving more frequency domain resources to be spread across multiple UEs 220. Thus, BWPs may also assist in the implementation of lower-capability (for example, RedCap) UEs 220 by facilitating the configuration of smaller bandwidths for communication by such UEs 220 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220. The network node 210 may transmit, to the UE 220, an indication of the selected MCS for the downlink signal, such as via DCI that schedules the downlink signal. As another example, the network node 210 may transmit, and the UE 220 may receive, an indication of an MCS to be applied for the one or more uplink signals, such as via DCI scheduling transmission of the one or more uplink signals.

The network node 210 or the UE 220 (such as by using the processing system 245 or the processing system 240, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 210 or the UE 220 (for example, using the processing system 245 or the processing system 240, respectively, and/or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 and/or one or more modems) may further perform spatial processing (for example, precoding) on the encoded information to generate one or more processed or precoded signals for downlink or uplink transmission, respectively. In some examples, the network node 210 or the UE 220 may perform codebook-based precoding or non-codebook-based precoding. Codebook-based precoding may involve selecting a precoder (for example, a precoding matrix) using a codebook. For example, the network node 210 may provide precoding information indicating which precoder, defined by the codebook, is to be used by the UE 220. Non-codebook-based precoding may involve selecting or deriving a precoder based on, or otherwise associated with, one or more downlink or uplink signal measurements. The network node 210 or the UE 220 may transmit the processed downlink or uplink signals, respectively, via one or more antennas.

The network node 210 or the UE 220 may receive uplink signals or downlink signals, respectively, via one or more antennas. The network node 210 or the UE 220 (for example, using the processing system 245 or the processing system 240, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 210 or the UE 220 via the downlink or uplink signals. The network node 210 or the UE 220 (for example, using the processing system 245 or the processing system 240, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 220 and a network node 210 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 210 and/or UE 220 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 210b may generate one or more beams 260a, and the UE 220b may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 210 and/or at the UE 220, such as in a network implementing mmWave technology. Massive MIMO may improve communication reliability by enabling a network node 210 and/or a UE 220 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 210 and the UE 220 may perform one or more beam management operations, such as an initial beam acquisition operation, one or more beam refinement operations, and/or a beam recovery operation. For example, an initial beam acquisition operation may involve the network node 210 transmitting signals (for example, SSBs, CSI-RSs, or other signals) via respective beams (for example, of the beams 260a of the network node 210) and the UE 220 receiving and measuring the signal(s) via respective beams of multiple beams (for example, from the beams 260b of the UE 220) to identify a best beam (or beam pair) for communication between the UE 220 and the network node 210. For example, the UE 220 may transmit an indication (for example, in a message associated with a random access channel (RACH) operation) of a (best) identified beam of the network node 210 (for example, by indicating an SSBRI or other identifier associated with the beam). A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 210 and the UE 220 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 265 (for example, one or more network nodes 210, one or more UEs 220, and/or one or more servers, and/or one or more components of a cloud computing network, among other examples). For example, in an deployment where AI/ML functionality is performed independently at a device 265, sometimes referred to as “overlay AI/ML”, the AI/ML model (or an instance or portion of the AI/ML model) may be deployed at a UE 220 (for example, at the processing system 240), a network node 210 (for example, at the processing system 245), one or more servers, and/or one or more components of a cloud computing network, among other examples. Additionally or alternatively, in a deployment where AI/ML functionality is coordinated between different devices 265, sometimes referred to as “coordinated AI/ML”, or performed at all device and network layers, sometimes referred to as “native AI/ML”, the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML and/or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, and/or efficient use of network bandwidth, and/or to reduce latency, among other examples). For example, the AI/ML model(s) may be trained to identify patterns or relationships in data corresponding to the wireless communication network 200, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 220, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 220 may include a communication manager 250. As described in more detail elsewhere herein, the communication manager 250 may transmit, during a first RACH occasion of one or more first RACH occasions, a first random access message that includes a first random access preamble; receive information indicating that one or more second RACH occasions are activated based on the first random access message being associated with a collision; and transmit, during a second RACH occasion of the one or more second RACH occasions, a second random access message that includes a second random access preamble. Additionally, or alternatively, the communication manager 250 may perform one or more other operations described herein.

In some aspects, the network node 210 may include a communication manager 255. As described in more detail elsewhere herein, the communication manager 255 may receive, during a first RACH occasion of one or more first RACH occasions, a first random access message associated with a second network entity, wherein the first random access message includes a first random access preamble; transmit information indicating that one or more second RACH occasions are activated based on the first random access message being associated with a collision; and receive, during a second RACH occasion of the one or more second RACH occasions, a second random access message associated with the second network entity, wherein the second random access message includes a second random access preamble. Additionally, or alternatively, the communication manager 255 may perform one or more other operations described herein.

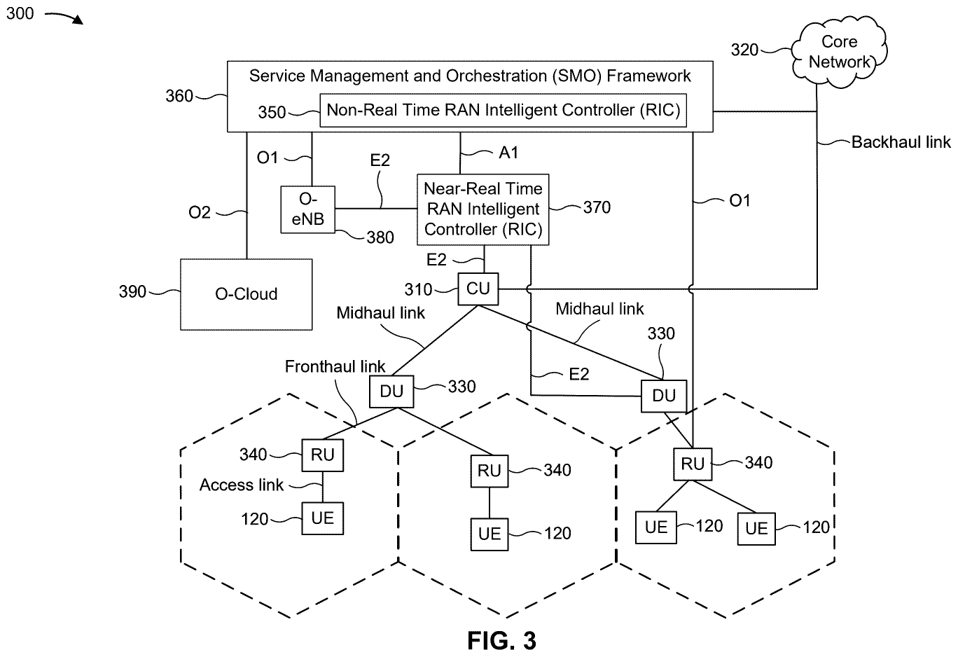

FIG. 3 is a diagram illustrating an example disaggregated network node architecture 300, in accordance with the present disclosure. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 and/or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

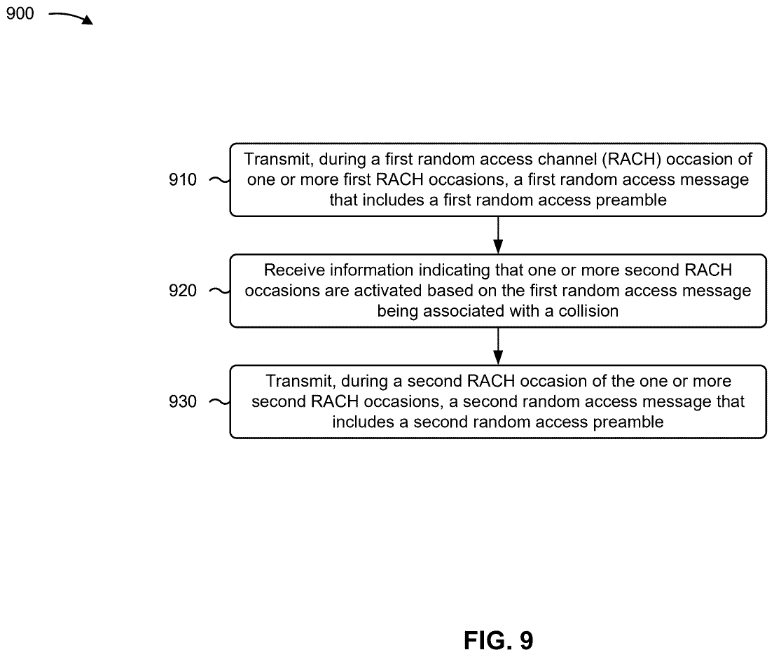

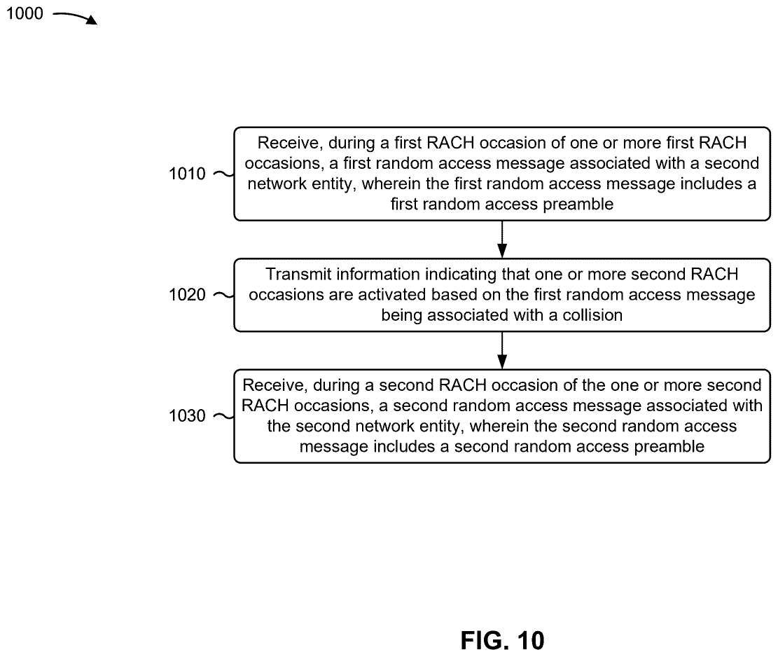

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with random access resources for collision handling, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 900 of FIG. 9, process 1000 of FIG. 10, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

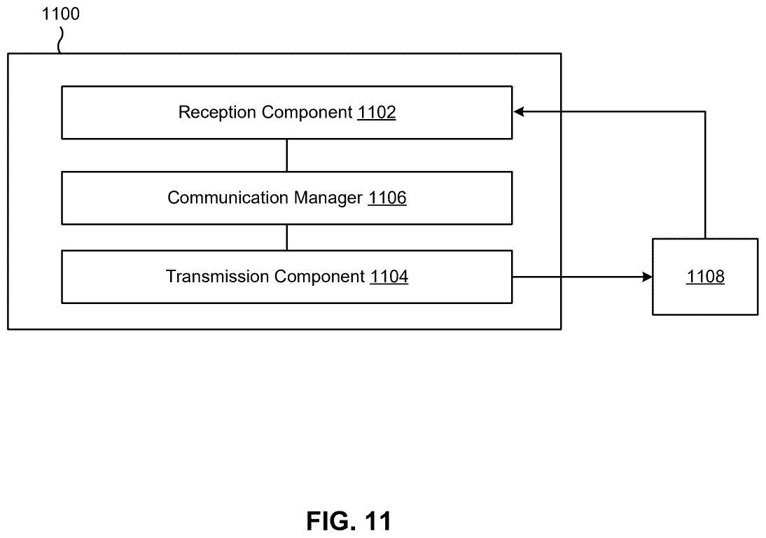

In some aspects, a network entity includes means for transmitting, during a first RACH occasion of one or more first RACH occasions, a first random access message that includes a first random access preamble; means for receiving information indicating that one or more second RACH occasions are activated based on the first random access message being associated with a collision; and/or means for transmitting, during a second RACH occasion of the one or more second RACH occasions, a second random access message that includes a second random access preamble. In some aspects, the means for the network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1102 depicted and described in connection with FIG. 11) and/or a transmission component (for example, transmission component 1104 depicted and described in connection with FIG. 11), among other examples.

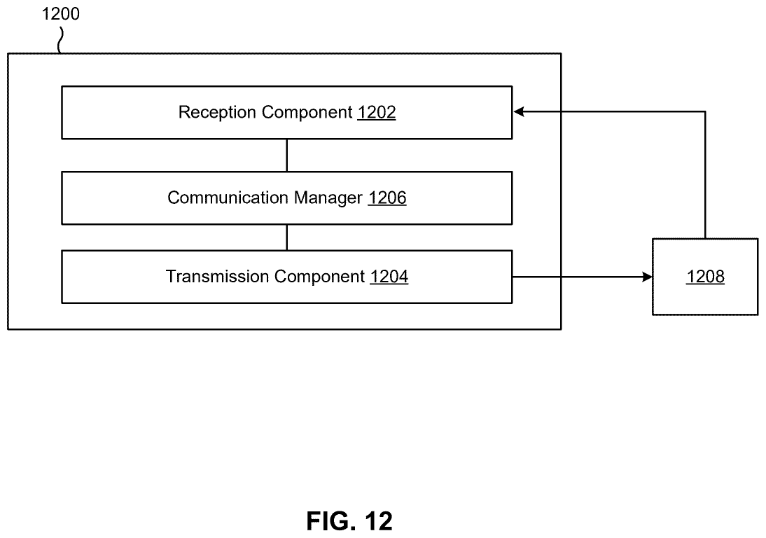

In some aspects, a network entity includes means for receiving, during a first RACH occasion of one or more first RACH occasions, a first random access message associated with a second network entity, wherein the first random access message includes a first random access preamble; means for transmitting information indicating that one or more second RACH occasions are activated based on the first random access message being associated with a collision; and/or means for receiving, during a second RACH occasion of the one or more second RACH occasions, a second random access message associated with the second network entity, wherein the second random access message includes a second random access preamble. In some aspects, the means for the network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

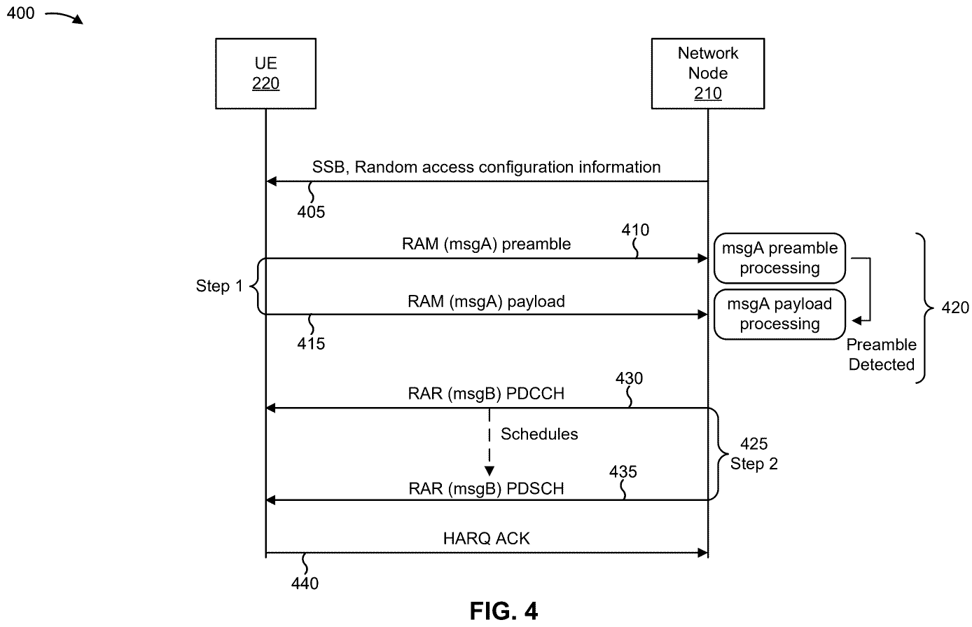

FIG. 4 is a diagram illustrating an example 400 of a two-step random access procedure, in accordance with the present disclosure. As shown in FIG. 4, a network node 210 and a UE 220 may communicate with one another to perform the two-step random access procedure.

As shown by reference number 405, the network node 210 may transmit, and the UE 220 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 410, the UE 220 may transmit, and the network node 210 may receive, a RAM preamble. As shown by reference number 415, the UE 220 may transmit, and the network node 210 may receive, a RAM payload. As shown, the UE 220 may transmit the RAM preamble and the RAM payload to the network node 210 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, an msgA preamble, a preamble, or a physical random access channel (PRACH) preamble, and the RAM payload may be referred to as a message A payload, an msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a PUSCH transmission).

As shown by reference number 420, the network node 210 may receive the RAM preamble transmitted by the UE 220. If the network node 210 successfully receives and decodes the RAM preamble, the network node 210 may then receive and decode the RAM payload.

As shown by reference number 425, the network node 210 may transmit an RAR (sometimes referred to as an RAR message). As shown, the network node 210 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 430, as part of the second step of the two-step random access procedure, the network node 210 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 435, as part of the second step of the two-step random access procedure, the network node 210 may transmit the PDSCH communication for the RAR, as scheduled by the PDCCH communication. The RAR may be included in a MAC protocol data unit (PDU) of the PDSCH communication. As shown by reference number 440, if the UE 220 successfully receives the RAR, the UE 220 may transmit a HARQ acknowledgement (ACK) indication.

As indicated above, FIG. 4 is provided as an example. Other examples may differ from what is described with regard to FIG. 4.

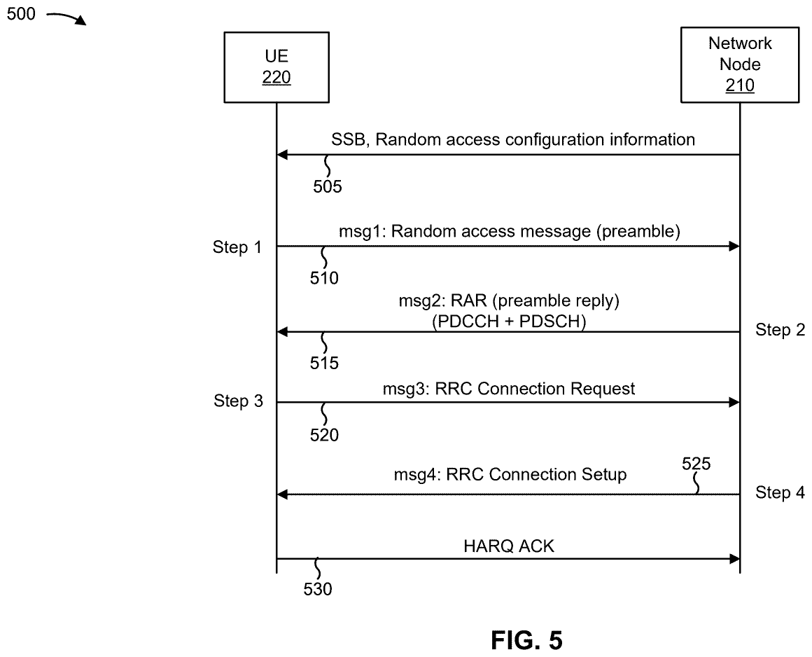

FIG. 5 is a diagram illustrating an example 500 of a four-step random access procedure, in accordance with the present disclosure. As shown in FIG. 5, a network node 210 and a UE 220 may communicate with one another to perform the four-step random access procedure.

As shown by reference number 505, the network node 210 may transmit, and the UE 220 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 510, the UE 220 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 210 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 220 in msg1). Additionally, or alternatively, the RAR may indicate a resource allocation to be used by the UE 220 to transmit message 3 (msg3).

In some aspects, as part of the second step of the four-step random access procedure, the network node 210 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 210 may transmit the PDSCH communication for the RAR, as scheduled by the PDCCH communication. The RAR may be included in a MAC PDU of the PDSCH communication.

As shown by reference number 520, the UE 220 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 525, the network node 210 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 530, if the UE 220 successfully receives the RRC connection setup message, the UE 220 may transmit a HARQ ACK indication.

As indicated above, FIG. 5 is provided as an example. Other examples may differ from what is described with regard to FIG. 5.

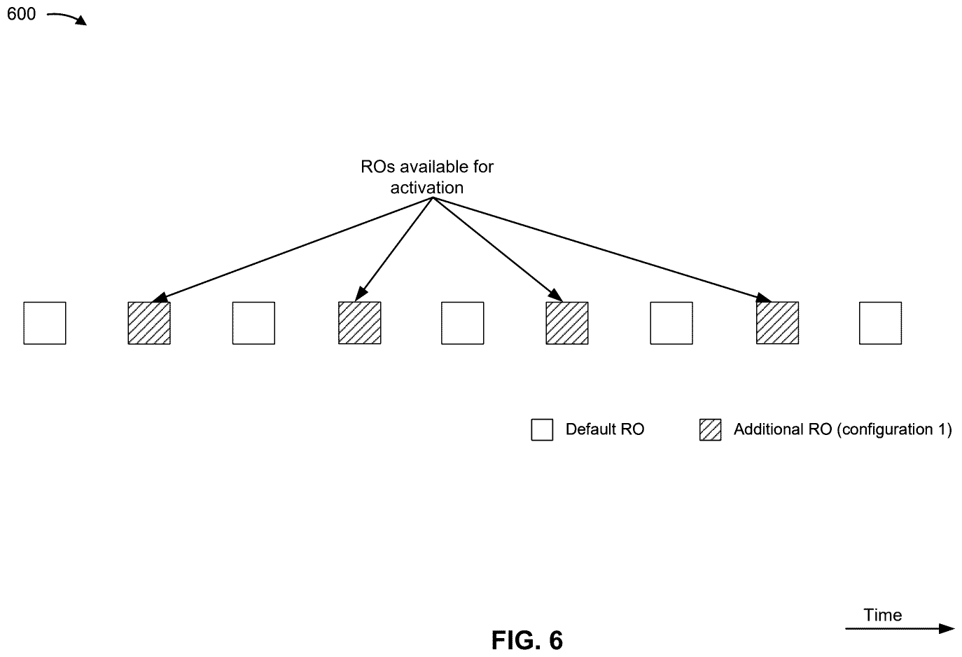

FIG. 6 is a diagram illustrating an example 600 of an activation of random access resource activation, in accordance with the present disclosure.

Network energy savings and/or network energy efficiency measures are expected to have increased importance in wireless network operations for various reasons, such as climate change mitigation, environmental sustainability, and/or network cost reduction, among other examples. For example, although NR generally offers a significant energy efficiency improvement per gigabyte over previous generations (e.g., LTE), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and most of the energy consumption and/or energy costs are associated with a RAN, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable adaptation for one or more PRACH parameters in a time domain. For example, a network node may generally provide a cell-wide PRACH configuration (e.g., in a SIB or SSB) that indicates various default PRACH parameters applicable to each UE in the cell and/or a UE-dedicated PRACH configuration that indicates default PRACH parameters applicable to one UE. For example, among other parameters, the default PRACH parameters may include one or more default PRACH resources (also known as RACH occasions or ROs) that correspond to time and frequency resources where a UE may transmit a PRACH message (e.g., an msg1 to initiate a four-step RACH procedure or an msgA preamble to initiate a two-step RACH procedure). Furthermore, the network node may configure (e.g., via semi-static signaling) one or more additional PRACH resources for one or more UEs operating in an RRC connected mode or an RRC idle/inactive mode, and the additional PRACH resources may initially be in a deactivated state. Accordingly, to enable network energy savings via PRACH adaptation in a time domain, the network node may always monitor the default PRACH resources (e.g., to detect PRACH messages from UEs attempting to acquire initial access to the cell), and may monitor the additional PRACH resources only when the additional PRACH resources have been activated. For example, the network node may dynamically activate the additional PRACH resources for a UE in an RRC connected mode or an RRC idle/inactive mode in a PDCCH order that triggers contention-based random access (CBRA) or contention-free random access (CFRA), and the network node may then monitor the dynamically activated PRACH resources for a PRACH message from the UE.

For example, as shown by example 600, a network node may provide a default always-on PRACH configuration (e.g., indicated in a SIB or an SSB using a RACH-ConfigCommon parameter, a RACH-ConfigGeneric parameter, or the like, or using a UE-dedicated signaling, such as a RACH-ConfigDedicated parameter) that configures relatively few default PRACH resources (e.g., default ROs in which a UE can transmit a PRACH message), and the network node may semi-statically configure additional PRACH resources for one or more UEs (e.g., UEs that have capabilities to support network energy savings features implemented by the network node). For example, the network node may configure (e.g., via semi-static signaling) one or more additional PRACH resources for one or more UEs operating in an RRC connected mode or an RRC idle/inactive mode, and the additional PRACH resources may initially be in a deactivated state. For instance, in example 600, the network node may semi-statically configure a first additional PRACH configuration (shown by a diagonal fill) that is associated with one or more ROs in addition to the default ROs. In some examples (e.g., as shown in example 600), the additional ROs may be separate from the default ROs. Alternatively, in some aspects, one or more additional ROs may overlap with the default ROs indicated in the default PRACH configuration.

Accordingly, to enable network energy savings via PRACH adaptation in a time domain, the network node may always monitor the default PRACH resources (e.g., to detect PRACH messages from UEs attempting to acquire initial access to the cell or enter a connected mode on the cell), and may monitor the additional PRACH resources only when the additional PRACH resources have been activated for one or more UEs. For example, the network node may dynamically activate the additional PRACH resources for a UE in an RRC connected mode or an RRC idle/inactive mode in a PDCCH order that triggers CBRA or CFRA, and the network node may then monitor the dynamically activated PRACH resources for a PRACH message from the UE. In some aspects, the PDCCH order may be indicated in a DCI message that has a particular format (e.g., DCI format 1_0) and a cyclic redundancy code (CRC) scrambled by a cell radio network temporary identifier (C-RNTI).

In some examples, two or more UEs may transmit random access messages (e.g., msg1 communications) to a network node using the same preamble (e.g., the same PRACH preamble) and the same RACH occasion (e.g., using the same time domain and/or frequency domain resources to transmit the RAM). A scenario in which two or more UEs transmit a RAM using the same preamble and the same RACH occasion may be referred to herein as a collision. A collision may also be referred to as a RACH collision, a PRACH collision, a preamble collision, a sequence (e.g., a preamble sequence) collision, and/or a sequence domain collision, among other examples. In such examples, the network node may be unable to distinguish between the two or more UEs. As a result, the network node may (e.g., in response to receiving multiple RAMs with the same preamble and via the same RACH occasion) consider a single UE to be detected. The network node may transmit a single RAR (e.g., in response to the multiple RAMs). Each UE (from the two or more UEs) may determine that a resource allocation indicated by the single RAR is granted for that UE. For example, each UE will treat an RAR uplink grant (e.g., indicated in an msg2) as allocated to itself (because the RAR uplink grant will use the preamble transmitted by each UE as a temporary ID to distinguish UEs). Each UE (from the two or more UEs) may transmit an msg3 using the resource allocation indicated by the single RAR (e.g., each UE may use the same RAR uplink grant to transmit an msg3).

As a result, the network node may perform one or more contention resolution operations to distinguish the two or more UEs that transmit respective msg3 communications using the same RAR uplink grant. This may consume processing resources, memory resources, and/or power resources associated with performing the contention resolution. In some cases, because the two or more UEs transmit respective msg3 communications using the same RAR uplink grant, the network node may fail to receive one or more of the msg3 communications (e.g., due to interference or other factors). As a result, UE(s) that transmit the failed msg3 communications may be unable to establish a connection with the network node, resulting in the UE(s) re-initiating the RACH procedure (e.g., thereby increasing latency associated with establishing a network connection and consuming network resources, processing resources, memory resources, and/or power resources associated with performing another RACH procedure).

As indicated above, FIG. 6 is provided as an example. Other examples may differ from what is described with regard to FIG. 6.

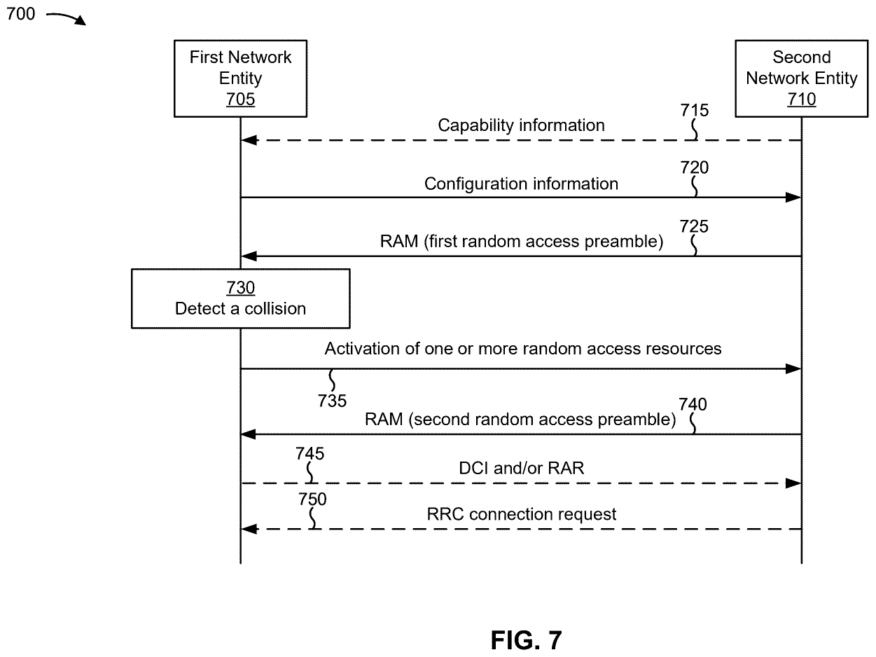

FIG. 7 is a diagram of an example 700 associated with random access resources for collision handling, in accordance with the present disclosure. As shown in FIG. 7, a first network entity 705 (e.g., the network entity 102, the network entity 104, the network entity 106, the network node 210, a base station, a CU, a DU, and/or an RU) may communicate with a second network entity 710 (e.g., the network entity 102, the network entity 104, the network entity 106, and/or the UE 220). In some aspects, the first network entity 705 and the second network entity 710 may be part of a wireless network (e.g., the wireless communication network 200 or the environment 100).

Although some examples are described herein using a certain type of random access procedure as an example, the techniques and aspects described herein can be similarly applied to any type of random access procedure (e.g., a two-step random access procedure, a three-step random access procedure, a four-step random access procedure, and/or another type of random access procedure). For example, an aspect described using a four-step random access procedure as an example may similarly be applied for two-step random access procedures, three-step random access procedures, and/or other types of random access procedures.

As used herein, the first network entity 705 “outputting” or “transmitting” a communication to the second network entity 710 may refer to a direct transmission (for example, from the first network entity 705 to the second network entity 710) or an indirect transmission via one or more other network nodes or devices, such as one or more TRPs or access nodes. For example, if the first network entity 705 is a DU or an access node controller, an indirect transmission to the second network entity 710 may include the first network entity 705 outputting or transmitting a communication to an RU (e.g., an access node or a TRP) and the RU transmitting the communication to the second network entity 710, or may include causing the RU to transmit the communication (e.g., triggering transmission of a physical layer reference signal). Similarly, the second network entity 710 “transmitting” a communication to the first network entity 705 may refer to a direct transmission (for example, from the second network entity 710 to the first network entity 705) or an indirect transmission via one or more other network nodes or devices, such as one or more TRPs or access nodes. For example, if the first network entity 705 is a DU or an access node controller, an indirect transmission to the first network entity 705 may include the second network entity 710 transmitting a communication to an RU (e.g., a TRP or an access node) and the RU transmitting the communication to the first network entity 705. Similarly, the first network entity 705 “obtaining” or “receiving” a communication may refer to receiving a transmission carrying the communication directly (for example, from the second network entity 710 to the first network entity 705) or receiving the communication (or information derived from reception of the communication) via one or more other network nodes or devices, such as one or more TRPs or access nodes.

In some aspects, as shown by reference number 715, the second network entity 710 may optionally transmit, and the first network entity 705 may receive, capability information. The capability information may be included in a capability report. The second network entity 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the second network entity 710. The one or more parameters may be indicated via respective information elements (IEs) included in a capability report.

The capability information may indicate whether the second network entity 710 supports a feature and/or one or more parameters related to the feature. For example, the capability information may indicate a capability and/or parameter for supporting additional random access resources (e.g., additional RACH occasions and/or additional PRACH resources). For example, the capability information may indicate that the second network entity 710 supports an NES capability for supporting the additional random access resources. In some examples, the capability information may indicate a capability and/or parameter for supporting random access resources which can be dynamically activated by the first network entity 705. In some aspects, the capability information may indicate that the second network entity 710 supports using the additional random access resources (e.g., additional RACH occasions and/or additional PRACH resources) for collision resolution, as described in more detail elsewhere herein. One or more operations described herein may be based on capability information. For example, the second network entity 710 may perform a communication in accordance with the capability information, or may receive configuration information that is in accordance with the capability information.

The first network entity 705 may determine configuration information (e.g., a RACH configuration or PRACH configuration) based on, using, or otherwise associated with the capability information. For example, if the capability information indicates that the second network entity 710 supports using the additional random access resources (e.g., additional RACH occasions and/or additional PRACH resources) for collision resolution, then the first network entity 705 may determine that the configuration information indicates a RACH configuration for random access resources (e.g., PRACH resources and/or one or more RACH occasions) that can be dynamically activated or deactivated by the first network entity 705. In other examples, the first network entity 705 may determine the configuration information without, or independently of, the capability information. For example, the first network entity 705 may determine that the second network entity 710 supports using the additional random access resources (e.g., additional RACH occasions and/or additional PRACH resources) for collision resolution as described herein based on a type, category, or other classification of the second network entity 710.

As shown by reference number 720, the first network entity 705 may transmit, and the second network entity 710 may receive, configuration information. In some aspects, the second network entity 710 may receive the configuration information via one or more of system information signaling (e.g., a master information block (MIB) and/or a system information block (SIB), among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include a random access configuration (e.g., a RACH configuration). For example, the configuration information may include an uplink BWP configuration (e.g., a BWP-UplinkCommon IE or parameter). The uplink BWP configuration may include or indicate one or more random access configurations, such as a common RACH configuration (e.g., a rach-ConfigCommon IE or parameter), a generic RACH configuration (e.g., a rach-ConfigGeneric IE or parameter), and/or one or more additional RACH configurations (e.g., indicated by an AdditionalRACH-ConfigList IE or parameter), among other examples. The common RACH configuration may indicate one or more random access parameters for a cell supported by the network node 210 (e.g., one or more cell-specific random access parameters).

The random access configuration may configure first random access resources (e.g., first RACH resources or first PRACH resources). The first random access resources may be included in a default always-on PRACH configuration (e.g., indicated in a SIB or an SSB using a RACH-ConfigCommon parameter, or a RACH-ConfigGeneric parameter, or using a UE-dedicated signaling, such as a RACH-ConfigDedicated parameter) that configures relatively few default PRACH resources (e.g., default RACH occasions in which the second network entity 710 can transmit a PRACH message). For example, the first random access resources may always be monitored by the first network entity 705. The first random access resources may include one or more first RACH occasions (e.g., that are always monitored by the first network entity 705)

The random access configuration may configure second random access resources (e.g., second RACH resources or second PRACH resources). The second random access resources may be optionally monitored by the first network entity 710. For example, the network node may configure (e.g., via semi-static signaling) one or more additional random access resources for the second network entity 710 (e.g., operating in an RRC connected mode or an RRC idle/inactive mode). The second random access resources (e.g., the additional PRACH resources and/or the additional RACH occasions) may initially be in a deactivated state. The deactivated state may be a state in which the first network entity 705 skips monitoring (e.g., refrains from monitoring and/or does not monitor) the second random access resources. An activated state may be a state in which the first network entity 705 monitors the second random access resources. For example, the first network entity 705 may semi-statically configure an additional random access configuration that is associated with one or more RACH occasions (e.g., the second random access resources) in addition to the default RACH occasions (e.g., the first random access resources). In some examples, the additional RACH occasions may be separate from the default RACH occasions. Alternatively, in some aspects, one or more additional RACH occasions may overlap with the default RACH occasions indicated in the default PRACH configuration. In some aspects, the configuration information may include multiple configurations for respective sets of additional random access resources (e.g., additional PRACH resources) in a similar manner.

As shown by reference number 725, the second network entity 710 may transmit, and the first network entity 705 may receive, a RAM (e.g., a first random access message). The RAM may include a first random access preamble (e.g., preamble x). For example, the RAM may be an msg.1, an msgA, and/or another type of random access message. The second network entity 710 may transmit the RAM using one or more random access resources included in the first random access resources (e.g., the default and/or always-on random access resources). For example, the second network entity 710 may transmit the RAM during a RACH occasion indicated or configured by the first random access resources (e.g., the default and/or always-on random access resources). For example, because the second random access resources (e.g., the additional PRACH resources and/or the additional RACH occasions) may be in the deactivated state, the second network entity 710 may not transmit random access messages using the second random access resources (e.g., because the second random access resources are not currently being monitored by the first network entity 710 for improved power savings by the first network entity 705).

As shown by reference number 730, the first network entity 705 may detect a collision. The first network entity 705 may detect the collision associated with the RAM (e.g., the first random access message) and/or the first random access preamble (e.g., the preamble x) transmitted by the second network entity 710. For example, one or more other network entities (e.g., not shown in FIG. 7) may transmit RAM(s) using the same one or more random access resources included in the first random access resources and including the same first random access preamble (e.g., the preamble x) used by the second network entity 710 (e.g., as described in connection with reference number 725). For example, two or more network entities (e.g., including the second network entity 710) may transmit the same random access preamble (e.g., the preamble x) at the same time (e.g., during the same RACH occasion), resulting in the collision. In some aspects, the first network entity 705 may detect collisions associated with one or more random access preambles.

The first network entity 705 may detect the collision using physical layer detection. For example, if two or more network entities (e.g., including the second network entity 710) transmit the same random access preamble (e.g., the preamble x) at the same time, then the first network entity 705 may detect that a received signal contains a combination of the two transmitted preambles. For example, the first network entity 705 may fail to decode the random access preamble (e.g., the preamble x) during the RACH occasion. The failed decoding may be indicative of the collision. Additionally, or alternatively, the first network entity 705 may detect that an energy level during the RACH occasion satisfies an energy threshold. The energy level satisfying the energy threshold may be indicative of multiple network entities transmitting the random access preamble (e.g., the preamble x) during the RACH occasion.

The first network entity 705 may determine that one or more additional random access resources (e.g., the second random access resources) are to be activated (e.g., transitioned to the active state) based on the collision detection. For example, the first network entity 705 may determine that one or more additional random access resources (e.g., the second random access resources) are to be activated for network entities (e.g., the second network entity 710) that transmitted the random access preamble(s) involved in the detected collision.

As shown by reference number 735, the first network entity 705 may transmit, and the second network entity 710 may receive, information indicating that one or more second RACH occasions (e.g., additional random access resources and/or additional PRACH resources) are activated based on the first random access message (e.g., the preamble x) being associated with the collision. The first network entity 705 may transmit the information using a dynamic indication, such as lower layer signaling. For example, the information may be included in MAC signaling (e.g., one or more MAC-CEs), and/or physical layer signaling (e.g., DCI), among other examples. For example, the information may be included in a control channel communication (e.g., a PDCCH communication). In some aspects, the information may be included in a PDCCH order that is included in DCI.

The information may indicate or include an identifier of the first random access preamble (e.g., the preamble x). This may be indicative of the one or more second RACH occasions (e.g., additional random access resources and/or additional PRACH resources) being activated for network entities (e.g., the second network entity 710) that transmitted the first random access preamble (e.g., the preamble x). For example, the information including the identifier of the first random access preamble (e.g., the preamble x) may indicate to the second network entity 710 that the second network entity 710 is to retry a transmission of the RAM in a RACH occasion that has been activated by the information (e.g., in a RACH occasion from the one or more second RACH occasions). The identifier may be a random access preamble identifier (RAPID). For example, the information may include, or indicate, the preamble identifiers for one or more preambles that experienced a collision. Additionally, the information may include an activation indication for one or more additional RACH occasions.

In some aspects, the first network entity 705 may transmit, and the second network entity 710 may receive, DCI for an RAR message. The DCI may include the information. For example, the DCI may be associated with scheduling an msg.2 or another random access message. In such examples, the DCI may include the identifier or indication of the first random access preamble (e.g., the preamble x). For example, the DCI may include the RAPID of the first random access preamble (e.g., the preamble x). As another example, the DCI may include a prefix indicative of the first random access preamble (e.g., the preamble x).

In some other examples, the first network entity 705 may transmit, and the second network entity 710 may receive, an RAR message. The RAR message (e.g., an msg.2 or another type of random access message) may include the information. For example, the first network entity 705 may transmit, and the second network entity 710 may receive, a data channel communication (e.g., a PDSCH communication) that includes the information. In such examples, the RAR message (e.g., the PDSCH communication) may include the identifier or indication of the first random access preamble (e.g., the preamble x). For example, the RAR message (e.g., the PDSCH communication) may include the RAPID of the first random access preamble (e.g., the preamble x). As another example, the RAR message (e.g., the PDSCH communication) may include a prefix indicative of the first random access preamble (e.g., the preamble x). In such examples, the second network entity 710 may determine that the RAR message is an activation of the one or more second RACH occasions (e.g., additional random access resources and/or additional PRACH resources), rather than a resource allocation for another random access message (such as an msg.3). For example, the second network entity 710 may interpret the RAR (e.g., the PDSCH communication of an msg.2) as an activation indication for the one or more second RACH occasions (e.g., additional random access resources and/or additional PRACH resources).

In some aspects, the information may indicate multiple random access preambles including the first random access preamble (e.g., the preamble x). For example, the information may include a first identifier of the first random access preamble (e.g., the preamble x) and a second identifier of a second random access preamble (e.g., a preamble y) based on the first network entity 705 detecting collisions for both the first random access preamble and the second random access preamble. The information may activate a set of RACH occasions (e.g., a set of additional RACH occasions or additional random access resources).

The information may indicate subsets of RACH occasions, of the set of RACH occasions, for respective random access preambles of the multiple random access preambles. For example, the information may indicate that network entities that transmitted the first random access preamble (e.g., the preamble x) are to use a first subset of RACH occasions from the set of RACH occasions activated by the information. Additionally, the information may indicate that network entities that transmitted the second random access preamble (e.g., the preamble y) are to use a second subset of RACH occasions from the set of RACH occasions activated by the information. For example, the second network entity 710 may select a RACH occasion from the first subset of RACH occasions of the set of RACH occasions. This enables the first network entity 705 to provide a dynamic allocation of resources for respective random access preambles that experience a collision. This provides additional flexibility for collision handling performed by the first network entity 705.

In some aspects, the activated random access resources (e.g., the one or more second RACH occasions activated by the information) may be deactivated based on an expiration of a timer. For example, the first network entity 705 and/or the second network entity 710 may initiate the timer based on the information (e.g., based on the transmission and/or reception of the information). After an expiration of the timer, the first network entity 705 and the second network entity 710 may consider the random access resources (e.g., the one or more second RACH occasions activated by the information) to be in the deactivated state. Additionally, or alternatively, activated random access resources (e.g., the one or more second RACH occasions activated by the information) may be deactivated after the second network entity 710 establishes a communication connection based on completing the random access procedure. For example, the activated random access resources (e.g., the one or more second RACH occasions activated by the information) may be deactivated after network entities (e.g., the second network entity 710) associated with the collision successfully connect to the wireless communication network.

As shown by reference number 740, the second network entity 710 may transmit, and the first network entity 705 may receive, a RAM. The RAM may be a retry of the RAM transmitted as described in connection with reference number 725. The RAM may include a second random access preamble (e.g., preamble z). For example, the second network entity 710 may determine (e.g., select) a new random access preamble to be transmitted in the retry of the RAM (e.g., based on the additional RACH occasion(s) being activated for the original random access preamble). The RAM may be an msg.1, an msgA, and/or another type of random access message. The second network entity 710 may transmit the RAM using one or more random access resources included in the second random access resources (e.g., the additional RACH occasion(s) activated by the information, as described in connection with reference number 735). For example, the second network entity 710 may transmit the RAM during a RACH occasion activated by the information. In some aspects, the RACH occasion may be included in a subset of RACH occasions that the information indicates is associated with the first random access preamble (e.g., the preamble x).

As shown by reference number 745, the first network entity 705 may transmit, and the second network entity 710 may receive, DCI and/or an RAR for the RAM transmitted as described in connection with reference number 740. For example, by the second network entity 710 using an activated RACH occasion (e.g., an additional RACH occasion) and selecting a new random access preamble, a likelihood of the first network entity 705 receiving and successfully decoding the random access preamble during the activated RACH occasion may be improved (e.g., because network entities associated with the collision of the first random access preamble may each select new random access preambles to transmit). Additionally, by the second network entity 710 using an activated RACH occasion to retry the RAM transmission, latency associated with collision handling for the collision may be reduced (e.g., because the second network entity 710 does not need to wait for a next default RACH occasion to retry the RAM).

For example, the first network entity 705 may transmit an RAR as a reply to the preamble (e.g., the preamble z). The message that includes the RAR may be referred to as message 2, msg.2, MSG2, or a second message in a four-step random access procedure. In some aspects, the RAR may indicate the detected random access preamble identifier (e.g., received from the second network entity 710 as described in connection with reference number 740). Additionally, or alternatively, the RAR may indicate a resource allocation to be used by the second network entity 710 to transmit message 3 (msg3).

In some aspects, as part of the second step of the four-step random access procedure, the first network entity 705 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the first network entity 705 may transmit the PDSCH communication for the RAR, as scheduled by the PDCCH communication. The RAR may be included in a MAC PDU of the PDSCH communication.

As shown by reference number 750, the second network entity 710 may transmit an RRC connection request message. The RRC connection request message may be referred to as message 3, msg.3, MSG3, or a third message of a four-step random access procedure. In some aspects, the RRC connection request may include an identifier, UCI, and/or a PUSCH communication (e.g., an RRC connection request).

In some aspects, the first network entity 705 may transmit an RRC connection setup message. The RRC connection setup message may be referred to as message 4, msg.4, MSG4, or a fourth message of a four-step random access procedure. In some aspects, the RRC connection setup message may include the detected identifier, a timing advance value, and/or contention resolution information. If the second network entity 710 successfully receives the RRC connection setup message, then the second network entity 710 may transmit a HARQ ACK indication. This enables the first network entity 705 and the second network entity 710 to establish an RRC connection and enable the second network entity 710 to access the wireless communication network.

As indicated above, FIG. 7 is provided as an example. Other examples may differ from what is described with regard to FIG. 7.

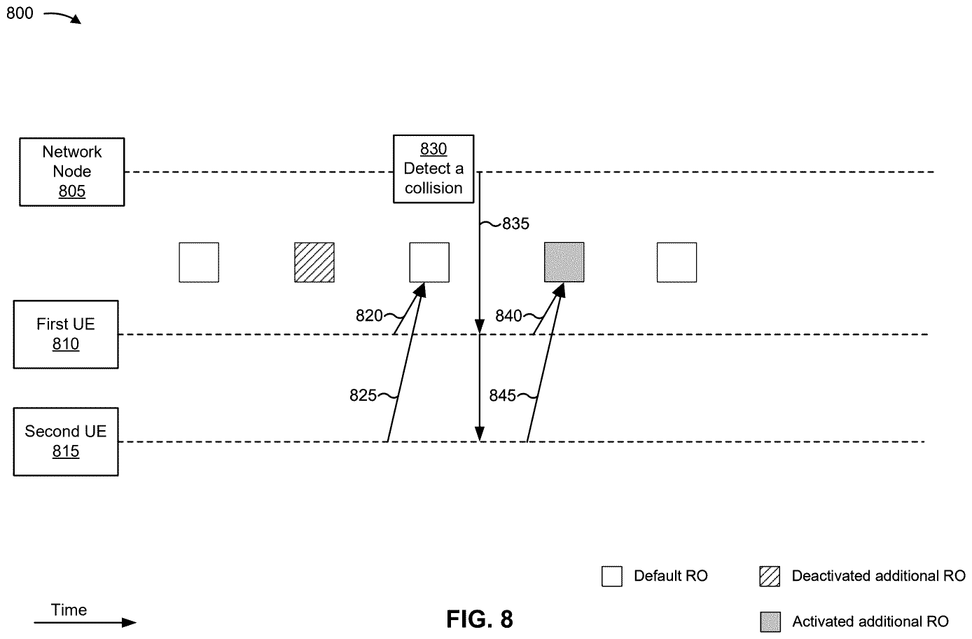

FIG. 8 is a diagram of an example 800 associated with random access resources for collision handling, in accordance with the present disclosure. As shown in FIG. 8, a network node 805 (e.g., a network entity, the first network entity 705, and/or a network node 210), a first UE 810 (e.g., a UE 220), and a second UE 815 (e.g., a UE 220) may operate in a wireless communication network (e.g., the environment 100 and/or the wireless communication network 200). In some aspects, the UE 810 may be the second network entity 710.

As shown in FIG. 8, the network node 805 may configure one or more default RACH occasions (e.g., default or always-on PRACH resources). Additionally, the network node 805 may configure one or more additional RACH occasions. The additional RACH occasions may be indicated as being in a deactivated state (e.g., a deactivated additional RACH occasion) or an activated state (e.g., an activated additional RACH occasion). In the deactivated state, the network node 805 may skip monitoring the additional RACH occasions. In the activated state, the network node 805 may monitor the additional RACH occasions. This may conserve power of the network node 805 that would have otherwise been associated with the network node 805 always monitoring the additional RACH occasions.

As shown in FIG. 8, the first UE 810 may transmit a RAM 820 during a default RACH occasion. The RAM 820 may include a random access preamble (e.g., the preamble x). For example, the first UE 810 may transmit the RAM 820 in a similar manner as described in connection with reference number 725.

The second UE 815 may transmit a RAM 825 during the default RACH occasion. The RAM 825 may include the random access preamble (e.g., the preamble x). For example, the RAM 820 and the RAM 825 may be transmitted using the same PRACH resources (e.g., during the default RACH occasion) and may both include the same random access preamble (e.g., the preamble x).

As shown by reference number 830, the network node 805 may detect a collision. For example, the network node 805 may detect the collision based on the RAM 820 and the RAM 825 being transmitted using the same PRACH resources (e.g., during the default RACH occasion) and both including the same random access preamble (e.g., the preamble x). For example, the network node 805 may detect the collision in a similar manner as described in connection with reference number 730.

The network node 805 may adapt PRACH transmissions for the first UE 810 and the second UE 815 based on the collision detection. For example, the network node 805 may transmit information 835 to activate one or more of the additional RACH occasions based on the collision detection. For example, the information 835 may include, or indicate, the random access preamble(s) associated with the detected collision(s). As an example, the information 835 may include an identifier (e.g., a RAPID) of the random access preamble (e.g., the preamble x) included in the RAM 820 and the RAM 825. The reception of the information 835 may indicate that the first UE 810 and the second UE 815 are to retry a RAM transmission using an additional RACH occasion activated by the information 835. In some aspects, the information 835 may be included in DCI scheduling an RAR. In some other aspects, the information 835 may be included in a PDSCH communication of an RAR. The information 835 may be similar to the information described elsewhere herein, such as in connection with reference number 735.

As shown in FIG. 8, the first UE 810 may transmit a RAM 840 during an activated additional RACH occasion. The RAM 840 may include a second (e.g., different) random access preamble (e.g., a preamble z). For example, the first UE 810 may transmit the RAM 840 in a similar manner as described in connection with reference number 740. The second UE 815 may transmit a RAM 845 during an activated additional RACH occasion. The RAM 845 may include a third (e.g., different) random access preamble (e.g., a preamble m). As a result, the network node 805 may be able to detect and/or decode the RAM 840 and the RAM 845 because the RAM 840 and the RAM 845 include different random access preambles. By using the activated additional RACH occasions for collision handling, the likelihood of the RAM 840 and the RAM 845 including different random access preambles may be improved because the first UE 810 and the second UE 815 may be enabled to select from a larger quantity of random access preambles (e.g., as compared to if a subset of one or more random access preambles were reserved for collision handling).

As indicated above, FIG. 8 is provided as an example. Other examples may differ from what is described with regard to FIG. 8.

FIG. 9 is a diagram illustrating an example process 900 performed, for example, at a first network entity or an apparatus of a first network entity, in accordance with the present disclosure. Example process 900 is an example where the apparatus or the first network entity (e.g., the second network entity 710, the network entity 102, the network entity 106, and/or the UE 220) performs operations associated with random access resources for collision handling.

As shown in FIG. 9, in some aspects, process 900 may include transmitting, during a first RACH occasion of one or more first RACH occasions, a first random access message that includes a first random access preamble (block 910). For example, the first network entity (e.g., using transmission component 1104 and/or communication manager 1106, depicted in FIG. 11) may transmit, during a first RACH occasion of one or more first RACH occasions, a first random access message that includes a first random access preamble, as described above.

As further shown in FIG. 9, in some aspects, process 900 may include receiving information indicating that one or more second RACH occasions are activated based on the first random access message being associated with a collision (block 920). For example, the first network entity (e.g., using reception component 1102 and/or communication manager 1106, depicted in FIG. 11) may receive information indicating that one or more second RACH occasions are activated based on the first random access message being associated with a collision, as described above.

As further shown in FIG. 9, in some aspects, process 900 may include transmitting, during a second RACH occasion of the one or more second RACH occasions, a second random access message that includes a second random access preamble (block 930). For example, the first network entity (e.g., using transmission component 1104 and/or communication manager 1106, depicted in FIG. 11) may transmit, during a second RACH occasion of the one or more second RACH occasions, a second random access message that includes a second random access preamble, as described above.

Process 900 may include additional aspects, such as any single aspect or any combination of aspects described below and/or in connection with one or more other processes described elsewhere herein.

In a first aspect, the information indicates an identifier of the first random access preamble.

In a second aspect, alone or in combination with the first aspect, transmitting the second random access message includes transmitting the second random access message using the second RACH occasion based on the information indicating the identifier of the first random access preamble.

In a third aspect, alone or in combination with one or more of the first and second aspects, the information indicating the identifier of the first random access preamble is indicative of the one or more second RACH occasions being activated for network entities, including the first network entity, that are associated with the collision.

In a fourth aspect, alone or in combination with one or more of the first through third aspects, the one or more second RACH occasions are deactivated based on an expiration of a timer, and process 900 includes initiating the timer based on the information.

In a fifth aspect, alone or in combination with one or more of the first through fourth aspects, the second random access message is associated with a random access procedure, and the one or more second RACH occasions are deactivated after the first network entity establishes a communication connection based on the random access procedure.

In a sixth aspect, alone or in combination with one or more of the first through fifth aspects, the one or more second RACH occasions include a set of RACH occasions, wherein the information indicates multiple random access preambles including the first random access preamble, and wherein the information indicates subsets of RACH occasions, of the set of RACH occasions, for respective random access preambles of the multiple random access preambles.

In a seventh aspect, alone or in combination with one or more of the first through sixth aspects, the information indicates that the first random access preamble is associated with a subset of RACH occasions of the set of RACH occasions, and the second RACH occasion is included in the subset of RACH occasions.

In an eighth aspect, alone or in combination with one or more of the first through seventh aspects, receiving the information includes receiving downlink control information for a random access response message, wherein the downlink control information includes the information.

In a ninth aspect, alone or in combination with one or more of the first through eighth aspects, the downlink control information includes an indication of an identifier of the first random access preamble.

In a tenth aspect, alone or in combination with one or more of the first through ninth aspects, receiving the information includes receiving a random access response message that includes the information.

In an eleventh aspect, alone or in combination with one or more of the first through tenth aspects, the random access response message includes an indication of an identifier of the first random access preamble.

In a twelfth aspect, alone or in combination with one or more of the first through eleventh aspects, the first random access message and the second random access message are a same type of random access message.

In a thirteenth aspect, alone or in combination with one or more of the first through twelfth aspects, transmitting the first random access message includes transmitting the first random access message to a second network entity, wherein receiving the information includes receiving the information from the second network entity, and wherein transmitting the second random access message includes transmitting the second random access message to the second network entity.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a first network entity or an apparatus of a first network entity, in accordance with the present disclosure. Example process 1000 is an example where the apparatus or the first network entity (e.g., the first network entity 705, the network entity 102, the network entity 106, and/or the network node 210) performs operations associated with random access resources for collision handling.

As shown in FIG. 10, in some aspects, process 1000 may include receiving, during a first RACH occasion of one or more first RACH occasions, a first random access message associated with a second network entity, wherein the first random access message includes a first random access preamble (block 1010). For example, the first network entity (e.g., using reception component 1202 and/or communication manager 1206, depicted in FIG. 12) may receive, during a first RACH occasion of one or more first RACH occasions, a first random access message associated with a second network entity, wherein the first random access message includes a first random access preamble, as described above.

As further shown in FIG. 10, in some aspects, process 1000 may include transmitting information indicating that one or more second RACH occasions are activated based on the first random access message being associated with a collision (block 1020). For example, the first network entity (e.g., using transmission component 1204 and/or communication manager 1206, depicted in FIG. 12) may transmit information indicating that one or more second RACH occasions are activated based on the first random access message being associated with a collision, as described above.

As further shown in FIG. 10, in some aspects, process 1000 may include receiving, during a second RACH occasion of the one or more second RACH occasions, a second random access message associated with the second network entity, wherein the second random access message includes a second random access preamble (block 1030). For example, the first network entity (e.g., using reception component 1202 and/or communication manager 1206, depicted in FIG. 12) may receive, during a second RACH occasion of the one or more second RACH occasions, a second random access message associated with the second network entity, wherein the second random access message includes a second random access preamble, as described above.

Process 1000 may include additional aspects, such as any single aspect or any combination of aspects described below and/or in connection with one or more other processes described elsewhere herein.

In a first aspect, process 1000 includes receiving, during the first RACH occasion, a third random access message associated with a third network entity, wherein the third random access message includes the first random access preamble, and wherein the first random access message is associated with the collision based on both the first random access message and the third random access message being received during the first RACH occasion and including the first random access preamble.

In a second aspect, alone or in combination with the first aspect, the information indicates an identifier of the first random access preamble.

In a third aspect, alone or in combination with one or more of the first and second aspects, transmitting the second random access message includes transmitting the second random access message using the second RACH occasion based on the information indicating the identifier of the first random access preamble.

In a fourth aspect, alone or in combination with one or more of the first through third aspects, the information indicating the identifier of the first random access preamble is indicative of the one or more second RACH occasions being activated for network entities, including the second network entity, that are associated with the collision.

In a fifth aspect, alone or in combination with one or more of the first through fourth aspects, the one or more second RACH occasions are deactivated based on an expiration of a timer, and process 1000 includes initiating the timer based on the information.

In a sixth aspect, alone or in combination with one or more of the first through fifth aspects, the second random access message is associated with a random access procedure, and the one or more second RACH occasions are deactivated after the first network entity establishes a communication connection based on the random access procedure.

In a seventh aspect, alone or in combination with one or more of the first through sixth aspects, the one or more second RACH occasions include a set of RACH occasions, wherein the information indicates multiple random access preambles including the first random access preamble, and wherein the information indicates subsets of RACH occasions, of the set of RACH occasions, for respective random access preambles of the multiple random access preambles.

In an eighth aspect, alone or in combination with one or more of the first through seventh aspects, the information indicates that the first random access preamble is associated with a subset of RACH occasions of the set of RACH occasions, and the second RACH occasion is included in the subset of RACH occasions.

In a ninth aspect, alone or in combination with one or more of the first through eighth aspects, the multiple random access preambles are associated with respective collisions including the collision.

In a tenth aspect, alone or in combination with one or more of the first through ninth aspects, transmitting the information includes transmitting downlink control information for a random access response message, wherein the downlink control information includes the information.

In an eleventh aspect, alone or in combination with one or more of the first through tenth aspects, the downlink control information includes an indication of an identifier of the first random access preamble.

In a twelfth aspect, alone or in combination with one or more of the first through eleventh aspects, transmitting the information includes transmitting a random access response message that includes the information.

In a thirteenth aspect, alone or in combination with one or more of the first through twelfth aspects, the random access response message includes an indication of an identifier of the first random access preamble.

In a fourteenth aspect, alone or in combination with one or more of the first through thirteenth aspects, the first random access message and the second random access message are a same type of random access message.

In a fifteenth aspect, alone or in combination with one or more of the first through fourteenth aspects, receiving the first random access message includes receiving the first random access message from the second network entity, wherein transmitting the information includes transmitting the information to the second network entity, and wherein receiving the second random access message includes receiving the second random access message from the second network entity.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network entity, or a network entity may include the apparatus 1100. In some aspects, the network entity may be a UE. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 114, the communication manager 118, and/or the communication manager 250. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, and/or the processing system 240).

In some aspects, the apparatus 1100 may be configured to perform one or more operations described herein in connection with FIGS. 7 and 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components described in connection with FIGS. 1-3. Additionally, or alternatively, one or more components shown in FIG. 11 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components described above in connection with FIGS. 1-3, such as a radio, one or more RF chains, one or more transceivers, or one or more modems, each of which may in turn be coupled with one or more antennas of the network entity.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, during a first RACH occasion of one or more first RACH occasions, a first random access message that includes a first random access preamble. The reception component 1102 may receive information indicating that one or more second RACH occasions are activated based on the first random access message being associated with a collision. The transmission component 1104 may transmit, during a second RACH occasion of the one or more second RACH occasions, a second random access message that includes a second random access preamble.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity, or a network entity may include the apparatus 1200. In some aspects, the network entity may be a network node. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 114, the communication manager 118, and/or the communication manager 255. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 110, the processing system 112, and/or the processing system 245).

In some aspects, the apparatus 1200 may be configured to perform one or more operations described herein in connection with FIGS. 7 and 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components described in connection with FIGS. 1-3. Additionally, or alternatively, one or more components shown in FIG. 12 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIGS. 1-3, such as a radio, one or more RF chains, one or more transceivers, or one or more modems, each of which may in turn be coupled with one or more antennas of the network entity.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, during a first RACH occasion of one or more first RACH occasions, a first random access message associated with a second network entity, wherein the first random access message includes a first random access preamble. The transmission component 1204 may transmit information indicating that one or more second RACH occasions are activated based on the first random access message being associated with a collision. The reception component 1202 may receive, during a second RACH occasion of the one or more second RACH occasions, a second random access message associated with the second network entity, wherein the second random access message includes a second random access preamble.

The reception component 1202 may receive, during the first RACH occasion, a third random access message associated with a third network entity, wherein the third random access message includes the first random access preamble, and wherein the first random access message is associated with the collision based on both the first random access message and the third random access message being received during the first RACH occasion and including the first random access preamble.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first network entity, comprising: transmitting, during a first random access channel (RACH) occasion of one or more first RACH occasions, a first random access message that includes a first random access preamble; receiving information indicating that one or more second RACH occasions are activated based on the first random access message being associated with a collision; and transmitting, during a second RACH occasion of the one or more second RACH occasions, a second random access message that includes a second random access preamble.

Aspect 2: The method of Aspect 1, wherein the information indicates an identifier of the first random access preamble.

Aspect 3: The method of Aspect 2, wherein transmitting the second random access message comprises: transmitting the second random access message using the second RACH occasion based on the information indicating the identifier of the first random access preamble.

Aspect 4: The method of any of Aspects 2-3, wherein the information indicating the identifier of the first random access preamble is indicative of the one or more second RACH occasions being activated for network entities, including the first network entity, that are associated with the collision.

Aspect 5: The method of any of Aspects 1-4, wherein the one or more second RACH occasions are deactivated based on an expiration of a timer, and the method further comprising: initiating the timer based on the information.

Aspect 6: The method of any of Aspects 1-5, wherein the second random access message is associated with a random access procedure, and wherein the one or more second RACH occasions are deactivated after the first network entity establishes a communication connection based on the random access procedure.

Aspect 7: The method of any of Aspects 1-6, wherein the one or more second RACH occasions include a set of RACH occasions, wherein the information indicates multiple random access preambles including the first random access preamble, and wherein the information indicates subsets of RACH occasions, of the set of RACH occasions, for respective random access preambles of the multiple random access preambles.

Aspect 8: The method of Aspect 7, wherein the information indicates that the first random access preamble is associated with a subset of RACH occasions of the set of RACH occasions, and wherein the second RACH occasion is included in the subset of RACH occasions.

Aspect 9: The method of any of Aspects 1-8, wherein receiving the information comprises: receiving downlink control information for a random access response message, wherein the downlink control information includes the information.

Aspect 10: The method of Aspect 9, wherein the downlink control information includes an indication of an identifier of the first random access preamble.

Aspect 11: The method of any of Aspects 1-10, wherein receiving the information comprises: receiving a random access response message that includes the information.

Aspect 12: The method of Aspect 11, wherein the random access response message includes an indication of an identifier of the first random access preamble.

Aspect 13: The method of any of Aspects 1-12, wherein the first random access message and the second random access message are a same type of random access message.

Aspect 14: The method of any of Aspects 1-13, wherein transmitting the first random access message comprises: transmitting the first random access message to a second network entity, wherein receiving the information comprises: receiving the information from the second network entity, and wherein transmitting the second random access message comprises: transmitting the second random access message to the second network entity.

Aspect 15: A method of wireless communication performed by a first network entity, comprising: receiving, during a first random access channel (RACH) occasion of one or more first RACH occasions, a first random access message associated with a second network entity, wherein the first random access message includes a first random access preamble; transmitting information indicating that one or more second RACH occasions are activated based on the first random access message being associated with a collision; and receiving, during a second RACH occasion of the one or more second RACH occasions, a second random access message associated with the second network entity, wherein the second random access message includes a second random access preamble.

Aspect 16: The method of Aspect 15, further comprising: receiving, during the first RACH occasion, a third random access message associated with a third network entity, wherein the third random access message includes the first random access preamble, and wherein the first random access message is associated with the collision based on both the first random access message and the third random access message being received during the first RACH occasion and including the first random access preamble.

Aspect 17: The method of any of Aspects 15-16, wherein the information indicates an identifier of the first random access preamble.

Aspect 18: The method of Aspect 17, wherein transmitting the second random access message comprises: transmitting the second random access message using the second RACH occasion based on the information indicating the identifier of the first random access preamble.

Aspect 19: The method of any of Aspects 17-18, wherein the information indicating the identifier of the first random access preamble is indicative of the one or more second RACH occasions being activated for network entities, including the second network entity, that are associated with the collision.

Aspect 20: The method of any of Aspects 15-19, wherein the one or more second RACH occasions are deactivated based on an expiration of a timer, and the method further comprising: initiating the timer based on the information.

Aspect 21: The method of any of Aspects 15-20, wherein the second random access message is associated with a random access procedure, and wherein the one or more second RACH occasions are deactivated after the first network entity establishes a communication connection based on the random access procedure.

Aspect 22: The method of any of Aspects 15-21, wherein the one or more second RACH occasions include a set of RACH occasions, wherein the information indicates multiple random access preambles including the first random access preamble, and wherein the information indicates subsets of RACH occasions, of the set of RACH occasions, for respective random access preambles of the multiple random access preambles.

Aspect 23: The method of Aspect 22, wherein the information indicates that the first random access preamble is associated with a subset of RACH occasions of the set of RACH occasions, and wherein the second RACH occasion is included in the subset of RACH occasions.

Aspect 24: The method of any of Aspects 22-23, wherein the multiple random access preambles are associated with respective collisions including the collision.

Aspect 25: The method of any of Aspects 15-24, wherein transmitting the information comprises: transmitting downlink control information for a random access response message, wherein the downlink control information includes the information.

Aspect 26: The method of Aspect 25, wherein the downlink control information includes an indication of an identifier of the first random access preamble.

Aspect 27: The method of any of Aspects 15-26, wherein transmitting the information comprises: transmitting a random access response message that includes the information.

Aspect 28: The method of Aspect 27, wherein the random access response message includes an indication of an identifier of the first random access preamble.

Aspect 29: The method of any of Aspects 15-28, wherein the first random access message and the second random access message are a same type of random access message.

Aspect 30: The method of any of Aspects 15-29, wherein receiving the first random access message comprises: receiving the first random access message from the second network entity, wherein transmitting the information comprises: transmitting the information to the second network entity, and wherein receiving the second random access message comprises: receiving the second random access message from the second network entity.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device for wireless communication, the device comprising a processing system, the processing system configured to perform the method of one or more of Aspects 1-30.

Aspect 39: A non-transitory computer-readable medium having code thereon that, when executed by a device, causes the device to perform the method of one or more of Aspects 1-30.

The foregoing disclosure provides illustration and description but is neither exhaustive nor limiting of the scope of this disclosure. For example, various aspects and examples are disclosed herein, but this disclosure is not limited to the precise form in which such aspects and examples are described. Modifications and variations may be made in light of the above disclosure or may be acquired from practice of the aspects.

As used herein, the term “component” shall be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. Systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and/or measuring, among other examples. Also, “determining” can include receiving (such as receiving information), accessing (such as accessing data stored in memory), and/or transmitting (such as transmitting information), among other examples. As another example, “determining” can include resolving, selecting, obtaining, choosing, establishing, and/or other such similar actions.

Even though particular combinations of features are recited in the claims and/or disclosed in the specification, these combinations do not limit the scope of the disclosure. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As used herein, a phrase referring to “at least one of” a list of items refers to any combination of those items, including single members. As an example, “at least one of: a, b, or c” covers a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” may include one or more items referenced in connection with the article “the” and may be used interchangeably with “the one or more.” Furthermore, as used herein, the terms “set” and “group” may include one or more items and may be used interchangeably with “one or more.” Where only one item is intended, the phrase “only one” or similar language is used. Also, as used herein, the terms “has,” “have,” “having,” and similar terms are open-ended terms that do not limit an element that they modify (for example, an element “having” A may also have B). Further, the phrase “based on” means “based on or otherwise in association with” unless explicitly stated otherwise. Additionally, as used herein, the phrase “based on” shall not be construed as a reference to a closed set of information, one or more conditions, one or more factors, or the like. Also, as used herein, the term “or” is inclusive when used in a series and may be used interchangeably with “and/or,” unless explicitly stated otherwise (for example, if used in combination with “either” or “only one of”). Further, “one or more” may be equivalent to “at least one.”

Even though particular combinations of features are recited in the claims or disclosed in the specification, these combinations are not limiting of the disclosure of various aspects. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
transmit, during a first random access channel (RACH) occasion of one or more first RACH occasions, a first random access message that includes a first random access preamble;
receive information indicating that one or more second RACH occasions are activated based on the first random access message being associated with a collision; and
transmit, during a second RACH occasion of the one or more second RACH occasions, a second random access message that includes a second random access preamble.

2. The first network entity of claim 1, wherein the information indicates an identifier of the first random access preamble.

3. The first network entity of claim 2, wherein, to transmit the second random access message, the processing system is configured to transmit the second random access message using the second RACH occasion based on the information indicating the identifier of the first random access preamble.

4. The first network entity of claim 2, wherein the information indicating the identifier of the first random access preamble is indicative of the one or more second RACH occasions being activated for network entities, including the first network entity, that are associated with the collision.

5. The first network entity of claim 1, wherein the one or more second RACH occasions are deactivated based on an expiration of a timer, and wherein the processing system is configured to:
initiate the timer based on the information.

6. The first network entity of claim 1, wherein the second random access message is associated with a random access procedure, and wherein the one or more second RACH occasions are deactivated after the first network entity establishes a communication connection based on the random access procedure.

7. The first network entity of claim 1, wherein the one or more second RACH occasions include a set of RACH occasions, wherein the information indicates multiple random access preambles including the first random access preamble, and wherein the information indicates subsets of RACH occasions, of the set of RACH occasions, for respective random access preambles of the multiple random access preambles.

8. The first network entity of claim 7, wherein the information indicates that the first random access preamble is associated with a subset of RACH occasions of the set of RACH occasions, and wherein the second RACH occasion is included in the subset of RACH occasions.

9. The first network entity of claim 1, wherein, to receive the information, the processing system is configured to:
receive downlink control information for a random access response message, wherein the downlink control information includes the information.

10. The first network entity of claim 9, wherein the downlink control information includes an indication of an identifier of the first random access preamble.

11. The first network entity of claim 1, wherein, to receive the information, the processing system is configured to:
receive a random access response message that includes the information.

12. The first network entity of claim 11, wherein the random access response message includes an indication of an identifier of the first random access preamble.

13. The first network entity of claim 1, wherein the first random access message and the second random access message are a same type of random access message.

14. The first network entity of claim 1, wherein, to transmit the first random access message, the processing system is configured to transmit the first random access message to a second network entity,
wherein, to receive the information, the processing system is configured to receive the information from the second network entity, and
wherein, to transmit the second random access message, the processing system is configured to transmit the second random access message to the second network entity.

15. A method of wireless communication performed by a first network entity, comprising:
transmitting, during a first random access channel (RACH) occasion of one or more first RACH occasions, a first random access message that includes a first random access preamble;
receiving information indicating that one or more second RACH occasions are activated based on the first random access message being associated with a collision; and
transmitting, during a second RACH occasion of the one or more second RACH occasions, a second random access message that includes a second random access preamble.

16. The method of claim 15, wherein the information indicates an identifier of the first random access preamble.

17. The method of claim 16, wherein transmitting the second random access message comprises:
transmitting the second random access message using the second RACH occasion based on the information indicating the identifier of the first random access preamble.

18. The method of claim 16, wherein the information indicating the identifier of the first random access preamble is indicative of the one or more second RACH occasions being activated for network entities, including the first network entity, that are associated with the collision.

19. The method of claim 15, wherein the one or more second RACH occasions are deactivated based on an expiration of a timer, and the method further comprising:
initiating the timer based on the information.

20. A non-transitory computer-readable medium having code stored thereon that, when executed by a first network entity, causes the first network entity to:
transmit, during a first random access channel (RACH) occasion of one or more first RACH occasions, a first random access message that includes a first random access preamble;
receive information indicating that one or more second RACH occasions are activated based on the first random access message being associated with a collision; and
transmit, during a second RACH occasion of the one or more second RACH occasions, a second random access message that includes a second random access preamble.
